(19) United States
(12) Patent Application Publication
(10) Pub. No.: US 2012/0240841 A1
(43) Pub. Date: Sep. 27, 2012

(54) SCALE-INDICATING DEVICE AND C-ARM X-RAY MACHINE

(76) Inventors: Xiang Yu Hu, Shanghai (CN); Xue Song Lu, Shanghai (CN); Guang Bao Sun, Shanghai (CN)

(21) Appl. No.: 13/427,773

(22) Filed: Mar. 22, 2012

(30) Foreign Application Priority Data
Mar. 23, 2011 (CN) CN 201110070155.9

(51) Int. Cl. G01D 13/06

(52) U.S. Cl. 116/284

(57) ABSTRACT

A scale-indicating device and a C-arm X-ray machine including the scale-indicating device are provided. The scale-indicating device includes a driven wheel, a driving wheel rotating synchronously with a rotating shaft to be measured, and a transmission belt having scale values and being in cooperation with the driving wheel and the driven wheel. The scale values on the transmission belt are used for indicating a rotated angle of the rotating shaft to be measured.

This application claims the benefit of CN 201110070155.9, filed on Mar. 23, 2011.

### TECHNICAL FIELD

The present embodiments relate to a scale-indicating device and a C-arm X-ray machine including the scale-indicating device.

### BACKGROUND

Scale-indicating devices are used in many application scenarios. Taking a C-arm X-ray machine as an example, in order to achieve multi-aspect and multi-angle X-ray examination of an object to be examined without changing the position of the object to be examined repeatedly, the C-arm of the X-ray machine may have several degrees of freedom. In order to learn the particular motion positions on certain degrees of freedom, scale-indicating devices may be provided for the motions in these degrees of freedom. For rotational motions (including bidirectional rotation or unidirectional rotation), a particular rotated angle of the C-arm may be indicated by using a scale-indicating device in the form of a standard index dial with a pointer.

Taking the C-arm X-ray machine shown in FIG. 1 as an example, FIG. 1 is a schematic structural diagram of a prior art C-arm X-ray machine, in which a first supporting member 12 of the C-arm X-ray machine may drive a C-arm 11 to rotate about its horizontal rotating shaft 13 (e.g., the C-arm 11 may carry out a first rotating motion A, as shown in FIG. 1). The maximum rotated angle range of the first rotating motion A is +/−180 degrees or unidirectional 360 degrees. A second supporting member 14 in some C-arm X-ray machines may drive the first supporting member 12 and the C-arm 11 to rotate about a vertical rotating shaft 15 (e.g., the C-arm 11 of certain X-ray machines may also carry out a second rotational motion B, as shown in FIG. 1). As to these rotating motions, in order to learn specific rotated angles, the scale indication of specific rotated angles may be achieved by fitting a pointer on the rotating shaft and fitting an index dial on a shaft seat. Alternatively, an index dial may be fit on the rotating shaft, and a pointer may be fit on the shaft seat in order to learn the specific rotated angles. Regarding such scale-indicating devices, the size of the index dial cannot be too large due to space restrictions, with the result that the words may be very small. An operator may not be able to observe the words from a distance. The scales at some corner positions may not be observable when the view is blocked.

### SUMMARY AND DESCRIPTION

The present embodiments may obviate one or more of the drawbacks or limitations in the related art. For example, a scale-indicating device and a C-arm X-ray machine having the scale-indicating device are provided so as to make it convenient for a user to observe a scale.

The scale-indicating device provided in the present embodiments includes a driven wheel, a driving wheel rotating synchronously with a rotating shaft to be measured, and a transmission belt having scale values and being in cooperation with the driving wheel and the driven wheel. The scale values on the transmission belt are used for indicating a rotated angle of the rotating shaft to be measured.

In one embodiment, the scale-indicating device further includes a plurality of equally spaced connecting blocks fastened on the transmission belt, with the scale values being located on the plurality of equally spaced connecting blocks.

In another embodiment, the scale-indicating device further includes a housing. A scale display window is provided on the housing, and the rotated angle of the rotating shaft to be measured is displayed through the scale display window.

The scale display window is provided with a pointer. The rotated angle of the rotation shaft to be measured is displayed by a position as indicated by the pointer.

Alternatively, a pointer is provided on the driven wheel. The rotated angle of the rotation shaft to be measured is displayed by the position as indicated by the pointer of the driven wheel. The device further includes a housing. The housing includes a scale display window, and the rotated angle of the rotating shaft to be measured is displayed through the scale display window.

In one embodiment, the rotated angle of the rotation shaft to be measured is displayed at a side of the driven wheel that is opposing the driving wheel.

In addition, the device may further include a tensioning wheel and/or a guide wheel.

In one embodiment, the driving wheel is fitted on the rotating shaft to be measured, and the driven wheel is fitted on a shaft seat or other defined fixed positions.

In another embodiment, the diameter of the driven wheel is smaller than the diameter of the driving wheel.

The C-arm X-ray machine provided in the present embodiments includes a scale-indicating device as described above.

By providing a driving wheel for rotating synchronously with a rotating shaft to be measured, a driven wheel and a transmission belt having scale values and being in cooperation with the driving wheel and the driven wheel, and using the transmission belt having scale values as a rotating index dial, the rotated angle of the rotating shaft to be measured is displayed synchronously by the scale values on the transmission belt. Such a rotating index dial using the rotation principle provides that the index dial scale does not have to be circular. Therefore, by adjusting the size of the transmission belt or adjusting the size of the auxiliary elements of the transmission belt (e.g., adjusting the size and distance of the connecting blocks), the adjustment of font size may be achieved, providing the font size of the scale. The scale is intuitive and easy to observe. In addition, in the case in which the scale is displayed at the side of the driven wheel that is opposing the driving wheel, by way of properly adjusting the distance between the driven wheel and the driving wheel, the problem that the view of the scale digits is blocked by corners of the X-ray machine may be avoided, making the scale convenient to observe.

In the present embodiments, since the length of the transmission belt is greater than the perimeter of the driving wheel, the scale range may be larger than 360 degrees (e.g., +/−190 degrees), which enables the technical solution in the present embodiments to be applied in the situations where the rotated angles exceeding +/—180 degrees or unidirectional 360 degrees are to be recorded. Such a function cannot be achieved by standard index dials.

Since the problem of the index dial having to be circular is solved by way of adding some proper tensioning wheels and/or guide wheels, the index dial in the present embodiments may be of any desired shape. The scale may be displayed at any desired position, thus making the scale convenient for a user to observe.

### BRIEF DESCRIPTION OF THE DRAWINGS

FIG. 1 shows a prior art C-arm X-ray machine;

FIG. 2 shows one embodiment of a scale-indicating device;

FIG. 3 is a planar front view of one embodiment of the scale-indicating device shown in FIG. 2;

FIG. 4 shows one embodiment of a scale-indicating device with a housing fitted on the C-arm X-ray machine; and

FIG. 5 is a partially enlarged view of one embodiment of the scale-indicating device shown in FIG. 4.

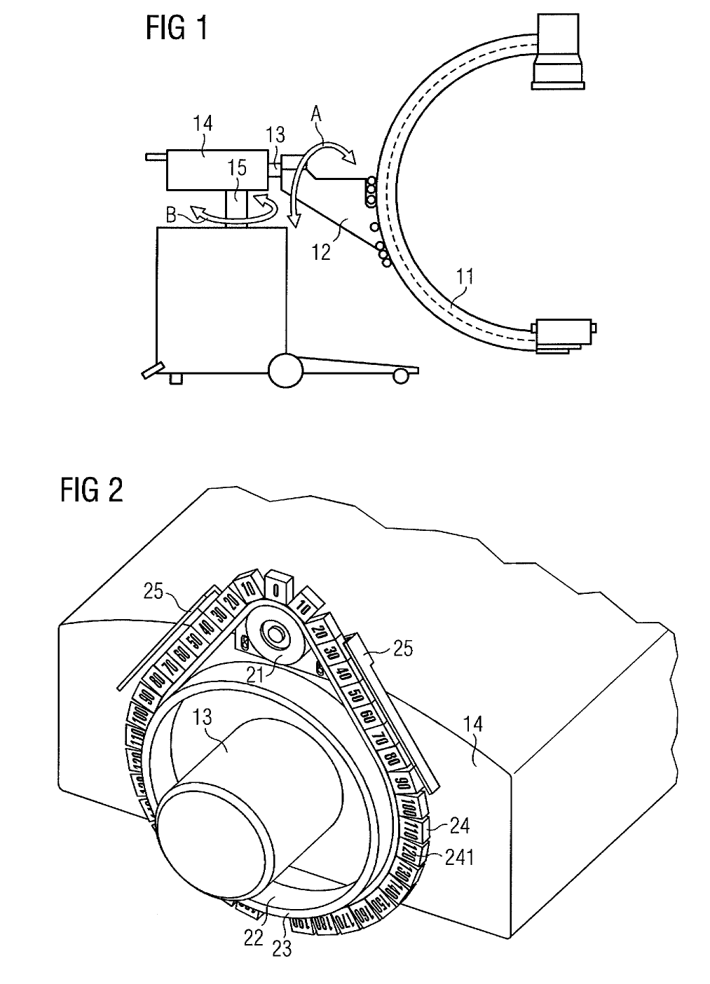

### DETAILED DESCRIPTION OF THE DRAWINGS

In consideration of the current situation that the above-mentioned problems, as faced by the scale-indicating devices in the form of currently available standard index dials when applied on some special occasions (e.g., a C-arm X-ray machine), have not been solved for a long time, the causes thereof are as follows: the shape of the index dial is circular, and the scale is fixed relative to the position of the index dial. When the radius of the index dial is to be increased for the sake of display requirements, the space occupied by the entire index dial is increased as well. Due to the space restrictions (e.g., application scenarios), however, the size of the index dial cannot be increased arbitrarily, thus resulting in the situation that the font size of the scale on the index dial is limited by the size of the index dial and cannot be increased arbitrarily either. Additionally, when the index dial cannot be made large enough, the scale on the index dial cannot be observed when the view is blocked by corners of certain rotating mechanisms.

The shape of the index dial may be changed. However, the index dial having such a shape has become deeply rooted in people's minds due to inertial thinking over a long time. For this reason, in order to design an index dial in other forms, a chain-type index dial using the synchronous transmission principle (e.g., by using a transmission belt wound around a rotating wheel as a rotating index dial), with scale values provided thereon is provided. A driving wheel among rotating wheels rotates synchronously with a rotating shaft to be measured, and scale values on a transmission belt are used for indicating a rotated angle of the rotating shaft to be measured.

The synchronous transmission principle may be applied in the standard transmission applications (e.g., converting a rotating motion into a linear motion or a variable speed motion). In one embodiment, the transmission belt is used as a rotating index dial.

In order to make the object, technical solutions and advantages of the present embodiments more apparent, the present embodiments are further described in detail below.

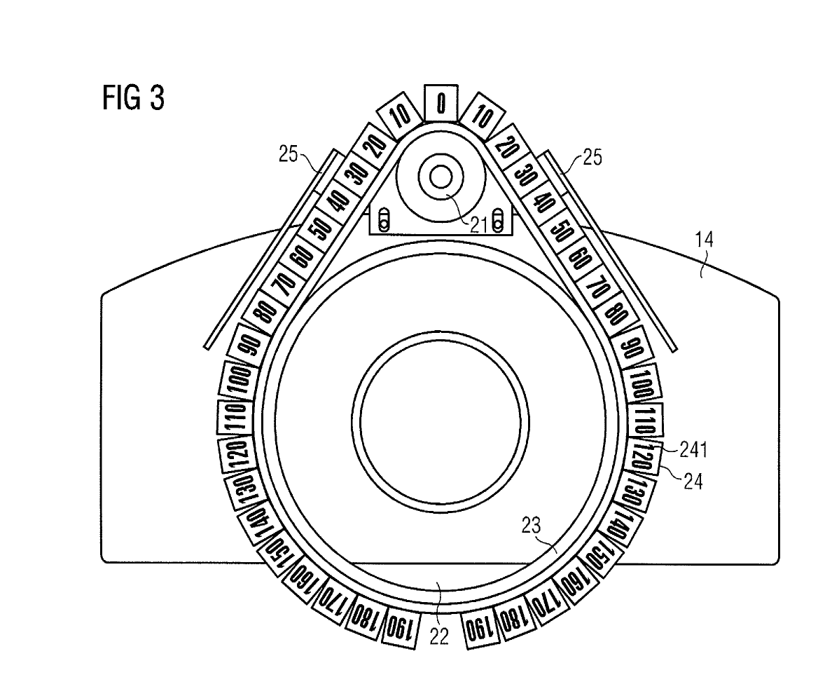

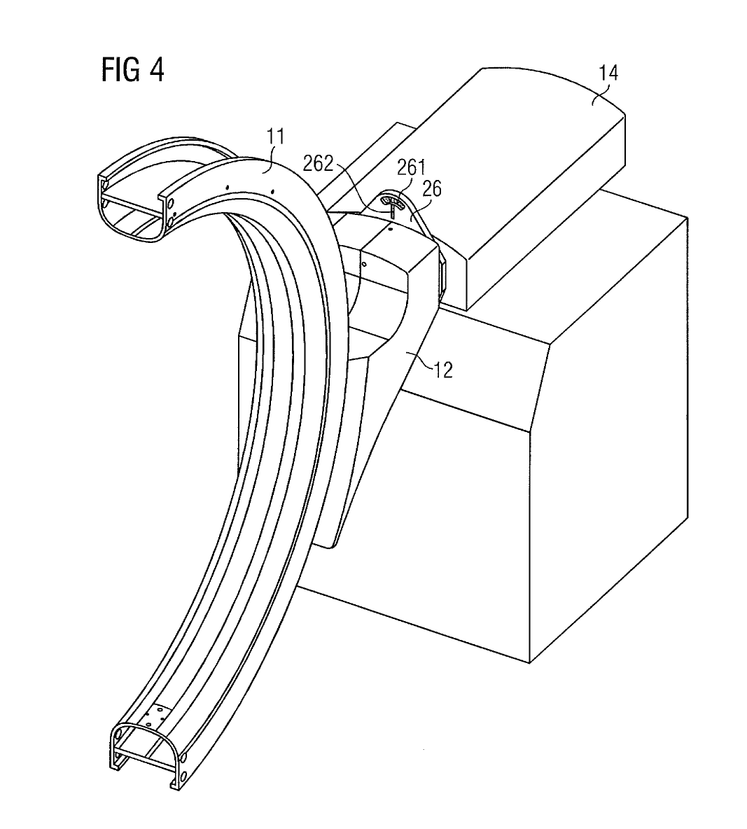

FIG. 2 is a perspective view of one embodiment of a scale-indicating device. FIG. 3 is a planar front view of one embodiment of the scale-indicating device shown in FIG. 2. FIGS. 2 and 3 show that taking the measurement of a rotated angle of a first rotating motion A as an example (e.g., the rotating shaft to be measured is a horizontal rotating shaft 13, as shown in FIG. 2), the scale-indicating device includes a driven wheel 21, a driving wheel 22 rotating synchronously with a rotating shaft 13 to be measured, a transmission belt 23 being in cooperation with the driving wheel 22 and the driven wheel 21, and a plurality of equally spaced connecting blocks 24 fastened on the transmission belt 23. Scale values 241 are provided on the plurality connecting blocks 24. The driving wheel 22 is fitted on the rotating shaft 13 to be measured, and the driven wheel 21 is fitted on a shaft seat corresponding to the horizontal rotating shaft 13 by a supporting plate 25 (e.g., on a second supporting member 14). The driven wheel 21 may also be fitted at other defined fixed positions.

The number of the connecting blocks 24 may be determined according to measurement range and measurement precision. In one embodiments, since the length of the transmission belt 23 is greater than the perimeter of the driving wheel 22, the measurement range may be larger than 360 degrees (e.g., +/−190 degrees, as shown in FIG. 2), which enables the present embodiments to be applied in the case where the rotated angles exceeding +/−180 degrees or unidirectional 360 degrees are to be recorded. In addition, in the embodiment shown in FIG. 2, taking the case in which the measurement precision is 10 degrees as an example, a measurement precision of 1 degree or 5 degrees, for example, may be set.

The length of the transmission belt 23, and the size and the fitting space of the connecting blocks 24 may be determined according to the display requirements to the font size and position. For example, by appropriately increasing the length of the transmission belt 23, the relative position between the driven wheel 21 and the driving wheel 22 may be varied, so as to vary the display position of the scale. By adjusting the size and the fitting space of the connecting blocks 24, the font size may be adjusted.

In one embodiment, in order to make the display of the rotated angle more apparent, the diameter of the driven wheel 21 may be set to be smaller than that of the driving wheel 22. The diameter of the driven wheel 21 may also be the same as or larger than that of the driving wheel 22. This may be determined according to practical requirements.

During implementation, the transmission belt 23 may include a standard chain with accessories.

In addition, the scale value 241 may, for example, be directly marked on the connecting blocks 24 or embossed on the connecting blocks 24. Alternatively, a label with the scale value 241 may be fixed on the connecting blocks 24. The particular implementations are not limited to the present embodiments.

In the scale-indicating device shown in FIG. 2, the rotated angle of the rotating shaft 13 to be measured may be displayed on a side of the driven wheel 21 that is opposing the driving wheel 22. For example, in FIG. 2, the driving wheel 22 is located beneath the driven wheel 21. Thus, the rotated angle is displayed above the driven wheel 21. Alternatively, some suitable tensioning wheels and/or guide wheels may further be provided, so as to enable the index dial to be present in other desired shapes. The rotated angle of the rotating shaft to be measured may also be displayed at any other desired positions, so as to further make the rotated angle convenient for a user to observe.

In one embodiment, in order to protect the internal structure of the scale-indicating device and to make the scale-indicating device dustproof, the scale-indicating device may further include a housing. In one embodiment, for the sake of making the observation of the scale convenient, the housing may be transparent. Alternatively, the housing may include a transparent scale display window. In order to indicate the current scale, a pointer mark may be provided on the scale display window, and the position indicated by the pointer mark corresponds to the current rotated angle of the rotating shaft 13 to be measured. Alternatively, a pointer may also be provided on the internal structure other than the housing. For example, for the case where the scale is displayed above the driven wheel 21, the pointer may be provided on the driven wheel 21. For the case where the scale is displayed at other positions, the pointer may accordingly be provided at a corresponding position. For example, the pointer is provided on the tensioning wheel, or the pointer is provided at a certain position between the tensioning wheel and the driven wheel. The pointer may be located on other structure.

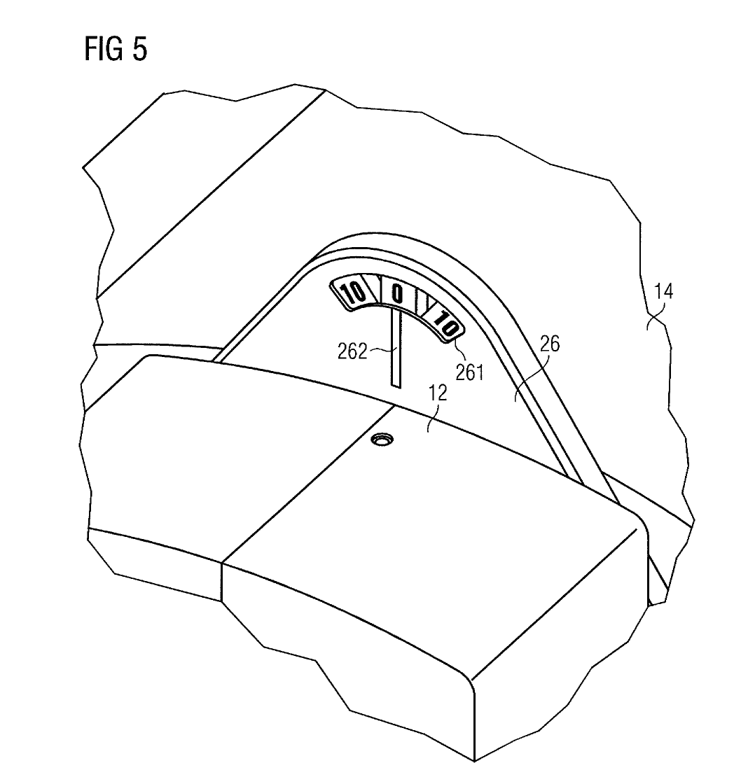

FIG. 4 is an exemplary structural diagram of one embodiment of the scale-indicating device with a housing fitted on a C-arm X-ray machine. FIG. 5 is a partially enlarged view of one embodiment of the scale-indicating device shown in FIG. 4. As shown in the embodiments of FIGS. 4 and 5, a housing 26 is provided on the basis of the scale-indicating device shown in FIG. 2. The housing 26 includes a scale display window 261, and a pointer mark 262 is provided on the scale display window 261. Additionally, a housing supporting structure may be provided on the supporting plate 25, and the housing 26 is fitted on the housing supporting structure.

In one embodiment, the connecting blocks 24 may not to be provided. The scale value 241 is directly provided on the transmission belt 23. For example, the scale value 241 may be provided on an outer surface of the transmission belt 23. A transmission belt 23 with a certain thickness may be provided, and the scale value 241 may be provided on a side surface of the transmission belt 23, so as to make the scale value 241 convenient to observe. Elements in other forms (e.g., a replacement element) may also be employed to replace the connecting blocks 24 mentioned above. The scale value 241 may be provided on the replacement element. The scale value 241 may be directly provided on the transmission belt and may also be indirectly provided on the transmission belt through other auxiliary elements; as long as a transmission belt has the scale values 241, it is to be covered in the scope of protection of the present embodiments.

The C-arm X-ray machine of the present embodiments is a C-arm X-ray machine including one embodiment of a scale-indicating device. For example, a C-arm X-ray machine is installed with the scale-indicating device of the present embodiments with respect to the first rotating motion A. Alternatively or additionally, a C-arm X-ray machine is installed with the scale-indicating device of the present embodiments with respect to the second rotating motion B.

The embodiments described above are not to limit the present invention, and any modifications, equivalent replacements and/or improvements within the spirit and principle of the present invention are to be covered in the scope of protection of the present invention.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A scale-indicating device comprising:
a driving wheel that rotates synchronously with a rotating shaft to be measured;
a driven wheel; and
a transmission belt that is in cooperation with the driving wheel and the driven wheel, the transmission belt having scale values, the scale values being used for indicating a rotated angle of the rotating shaft to be measured.

2. The scale-indicating device as claimed in claim 1, further comprising a plurality of equally spaced connecting blocks fastened on the transmission belt,
wherein the scale values are located on the plurality of equally spaced connecting blocks.

3. The scale-indicating device as claimed in claim 2, further comprising a housing having a scale display window,
wherein the rotated angle of the rotating shaft to be measured is displayed through the scale display window.

4. The scale-indicating device as claimed in claim 3, wherein the scale display window comprises a pointer, and
wherein the rotated angle of the rotation shaft to be measured is displayed by a position as indicated by the pointer.

5. The scale-indicating device as claimed in claim 2, wherein the driven wheel comprises a pointer, and
wherein the rotated angle of the rotation shaft to be measured is displayed by a position as indicated by the pointer.

6. The scale-indicating device as claimed in claim 5, further comprising a housing having a scale display window,
wherein the rotated angle of the rotating shaft to be measured is displayed through the scale display window.

7. The scale-indicating device as claimed in claim 1, wherein the rotated angle of the rotation shaft to be measured is displayed on a side of the driven wheel that is opposing the driving wheel.

8. The scale-indicating device as claimed in claim 1, further comprising a tensioning wheel, a guide wheel, or tensioning and guide wheels.

9. The scale-indicating device as claimed in claim 1, wherein the driving wheel is fitted on the rotating shaft to be measured, and
wherein the driven wheel is fitted on a shaft seat or other defined fixed positions.

10. The scale-indicating device as claimed in claim 1, wherein the diameter of the driven wheel is smaller than the diameter of the driving wheel.

11. A C-arm X-ray machine comprising:
a scale-indicating device comprising:
a driving wheel that rotates synchronously with a rotating shaft to be measured;
a driven wheel; and
a transmission belt that is in cooperation with the driving wheel and the driven wheel, the transmission belt having scale values, the scale values being used for indicating a rotated angle of the rotating shaft to be measured.

12. The C-arm X-ray machine as claimed in claim 11, wherein the scale-indicating device further comprises a plurality of equally spaced connecting blocks fastened on the transmission belt, and
wherein the scale values are located on the plurality of equally spaced connecting blocks.

13. The C-arm X-ray machine as claimed in claim 12, wherein the scale-indicating device further comprises a housing having a scale display window, and
wherein the rotated angle of the rotating shaft to be measured is displayed through the scale display window.

14. The C-arm X-ray machine as claimed in claim 12, wherein the scale display window comprises a pointer, and
wherein the rotated angle of the rotation shaft to be measured is displayed by a position as indicated by the pointer.

15. The C-arm X-ray machine as claimed in claim 12, wherein the driven wheel comprises a pointer, and
wherein the rotated angle of the rotation shaft to be measured is displayed by a position as indicated by the pointer.

16. The C-arm X-ray machine as claimed in claim 15, wherein the scale-indicating device further comprises a housing having a scale display window, and
wherein the rotated angle of the rotating shaft to be measured is displayed through the scale display window.

17. The C-arm X-ray machine as claimed in claim 11, wherein the rotated angle of the rotation shaft to be measured is displayed on a side of the driven wheel that is opposing the driving wheel.

18. The C-arm X-ray machine as claimed in claim 11, wherein the scale-indicating device further comprises a tensioning wheel, a guide wheel, or tensioning and guide wheels.

19. The C-arm X-ray machine as claimed in claim 11, wherein the driving wheel is fitted on the rotating shaft to be measured, and
wherein the driven wheel is fitted on a shaft seat or other defined fixed positions.

20. The C-arm X-ray machine as claimed in claim 11, wherein the diameter of the driven wheel is smaller than the diameter of the driving wheel.
